(19) United States
(12) Patent Application Publication
(10) Pub. No.: US 2006/0231371 A1
(43) Pub. Date: Oct. 19, 2006

(54) Transport device for a motor vehicle or a partially assembled motor vehicle during the production process

(76) Inventors: Frederic De Moliere, Muhlberg (DE); Gerhard Mogck, Untergruppenbach (DE); Thomas Tentrup, Merzig (DE); Gernot Spiegelberg, Heimsheim (DE)

Correspondence Address: WILLIAM COLLARD;COLLARD & ROE, P.C., 1077 NORTHERN BOULEVARD, ROSLYN, NY, 11576, US

(21) Appl. No.: 10/567,270

(22) PCT Filed: Aug. 5, 2004
(86) PCT No.: PCT/DE04/01762

§ 371 Date: Mar. 23, 2006

(51) Int. Cl. G01M 15/00

(52) U.S. Cl. 198/341.09; 73/116

(57) ABSTRACT

This invention relates to a transport device for a motor vehicle or partially assembled motor vehicle during the production process. The transport device is configured to receive a motor vehicle or partially assembled motor vehicle, said motor vehicle or partially assembled motor vehicle being conveyed by means of the transport device to the various work stations. The transport device, which is continuously supplied with power during the production process, has a terminal for supplying power to the on-board electrical system of the motor vehicle or partially assembled motor vehicle to be conveyed by the transport device. This terminal can be connected up to the on-board electrical system of the vehicle or partially assembled vehicle.

This invention relates to a transport device for a motor vehicle or a partially assembled motor vehicle during the production process according to the preamble of claim 1.

Transport devices of this kind are known. Dürr Automation GmbH in Stuttgart offers a system of this kind, in which various kinds of transport devices can be supplied with electrical energy. This system, known as “MOVITRANS”, is offered, for example, in the 2003/2004 catalogue. The system permits the wired, yet contact-free transfer of power and information to the individual, movable transport devices. Transport devices include the vehicle suspension units in overhead rail conveyance systems as well as skillet conveyors and so-called AGVs (automated guide vehicle systems). The transport devices are configured to receive vehicles or partially assembled vehicles during the production process, the vehicles or partially assembled vehicles being conveyed by means of these transport devices to the various work stations along the assembly line. At these work stations, the vehicles or partially assembled vehicles undergo tests and/or further assembly operations. The MOVITRANS system is described, for example, on pages 22 and 23 of Dürr Automation GmbH's 2003/2004 product catalogue.

The object of this invention is to propose a means for the flexible testing and configuration of vehicles during the production process.

This object is established according to the invention by providing the transport device with a terminal for supplying power to the on-board electrical system of the motor vehicle or partially assembled motor vehicle to be conveyed by the transport device, the on-board electrical system of the motor vehicle or partially assembled motor vehicle being connectable to said terminal, and said terminal being supplied with electrical energy via the transport device's contact-free power supply.

The advantage of this is that the vehicle's on-board voltage is already available during the production process, which means that the vehicle's electrical and electronic components (e.g. controllers in the vehicle) can already be tested—in particular for their proper working order—during the production process.

It is to advantage that power is supplied via an already existent system, with which a “circulating” power supply for the production hall and, in particular, the movable transport devices therein is organised, so that no additional contacts, rails and sliding contacts are needed for the external power supply to the vehicle or partially assembled vehicle.

The on-board voltage is still available after the vehicle has passed through the work station at which the vehicle's battery is installed and connected up. Thanks to this invention, tests performed on the electrical components do not draw on the battery, thus preventing any significant discharging during the production process.

This is of particular benefit in view of the increasing number of electrical components in vehicles and the resulting increase in the number of tests that are necessary. The fact that the vehicle can already be supplied externally with the on-board voltage while the vehicle is still in the transport device has the advantage that electrical components can already be tested during the production process.

Of particular benefit is the fact that tests can be performed as soon as all the necessary components for the given function packages have been fitted and connected up at the work stations concerned. If faults are detected and the necessary corrective measures are not excessive, these faults can advantageously be ironed out at the work station in question. This obviates the necessity of removing the vehicle from the assembly line for purposes of corrective action.

In the embodiment according to claim 2, the terminal can be activated and deactivated by a control unit.

The advantage of this is that the on-board electrical system can be de-energized if this is necessary to ensure employee safety or to avoid damage to electrical components during assembly work at any one work station. Once the assembly work in question has been completed, the external power supply can be reactivated.

In the embodiment according to claim 3, the control unit is a centralised host computer.

The information transfer to the transport device may be realised by means of a local network. This may be effected, for example, by means of the MOVITRANS system described under the prior art. When the transport device approaches certain work stations, the host computer may thus specify that the terminal on the transport device be deactivated, thus interrupting the external power supply to the vehicle.

In the embodiment according to claim 4, the control unit is a mobile control unit that can be attached removably to the transport device or to the motor vehicle or partially assembled motor vehicle being conveyed by the transport device; power can be supplied to said mobile control unit via the transport device.

It is practical that the mobile control unit can also be supplied with power via the on-board system, independently of the terminal on the transport device. This means that the mobile control unit can still be supplied with power even if the external power supply to the vehicle has been deactivated. The mobile control unit thus remains fully functional even if the external power supply to the vehicle is interrupted.

As an alternative to or in addition to having the mobile control unit activate and deactivate the external power supply to the vehicle, provision may be made for the centralised host computer to activate and deactivate the external power supply to the vehicle.

If the external power supply can not be activated and deactivated by the centralised host computer but only by the mobile control unit, this function is a decentralised function.

If the external power supply can be activated and deactivated by both the host computer and the mobile control unit, it is possible, for example, for the host computer to initially deactivate the external power supply as a work station is approached, so that the necessary assembly operations can be performed. Once these assembly operations have been completed, which can be established, for example, by way of an appropriate dialogue between the assembly worker and the mobile control unit, the mobile control unit can reactivate the external power supply so that, for example, the necessary functional tests can be performed on the components just fitted.

In the embodiment according to claim 5, the mobile control unit can be linked up to a diagnostic connector in the vehicle.

This makes it possible, for example, for the mobile control unit to learn, prior to the production process, which function package is to be realised in the vehicle to be produced. The software for the controllers needed in the vehicle for these functions can then be loaded from the mobile control unit via the diagnostic connector. The link-up with the vehicle's diagnostic connector also permits the appropriate tests to be carried out during the production process.

In the embodiment according to claim 6, a mobile control unit can be attached removably to the transport device or to the motor vehicle or partially assembled motor vehicle being conveyed by the transport device; power can be supplied to the mobile unit via the transport device or via the vehicle's electrical system, and the mobile unit can be linked up to a diagnostic connector in the vehicle.

In contrast to the embodiment according to claims 4 and 5, the transport device's terminal for supplying external power to the vehicle can not be activated and deactivated by the mobile control unit. In all other respects, this embodiment works in exactly the same way as previously explained.

In the embodiment according to claim 7, the transport device is integrated in a network for wired data exchange with a host computer. When mounted, the mobile control unit is likewise integrated in the wired data-exchange network.

This arrangement permits data exchange between the mobile control unit and the host computer. For example, the results of tests carried out can be transmitted from the mobile control unit to the host computer. Similarly, current software versions can be transmitted from the host computer to the mobile control units. It is to advantage that this can also be effected during the production process at times when the mobile control units are not in use. The wired network may, for example, be the “MOVITRANS” system described at the beginning.

In the embodiment according to claim 8, the mobile control unit is equipped with a transmitter/receiver unit for wireless data exchange with a host computer or with other stationary or mobile control computers. These other control computers may, for example, be test stations along the assembly line or assembly workers' hand terminals.

Provided it is equipped with the full range of functions, the mobile control unit thus constitutes a mobile test and configuration computer. Configuration is effected by transfer to the vehicle—by means of the mobile control unit—of the software needed for the vehicle's equipment package and by activating the various functions in the vehicle. This applies to a vehicle variant in which the hardware and the necessary components for defined equipment packages are installed, and the software that enables these components to work is activated by an appropriate control unit.

The advantage of having the mobile control unit attached removably to the transport device or to the vehicle or partially assembled vehicle is that the mobile control unit can remain with the vehicle if the vehicle has to be removed from the assembly line because a fault has been detected. The mobile control unit can then be deposited expediently in the vehicle, and because the equipment package intended for the vehicle in question is stored in the mobile control unit, the vehicle can easily be re-integrated in the production process—for instance, when the fault has been rectified. As a result, no special preparations need be made before returning a vehicle that was removed from the assembly line, providing the fault has been rectified. The vehicle can be re-integrated in the production process without any problem at all.

The drawing shows a transport device 1. A vehicle 2 is attached to this transport device 1. The vehicle 2 can be conveyed with the transport device 1 in the direction of the arrow, thus enabling it to pass through the various work stations during the production process.

Assembly operations and also tests may be performed at the individual work stations. Via the suspension means for the transport device 1, voltage can be applied to a terminal 3 on the transport device 1. The on-board electrical system of the vehicle 2 can be connected to this terminal 3 with the cable 4 shown here.

The terminal 3 on the transport device 1 can be activated and deactivated, with the advantage that by way of said terminal, the external power supply to the vehicle 2 can be switched on and off.

The terminal 3 can, in the first instance, be activated/deactivated via a host computer 5. To this end, the transport device 1 is not-only supplied with electrical energy via the suspension means. In addition, a wired connection is provided for data exchange. Via this wired connection between the host computer 5 and the transport device 1 (and hence also the terminal 3), the external power supply to the vehicle 2 can be switched on and off.

Alternatively, or in addition, the terminal 3 can be controlled via a mobile control unit 6. This option is illustrated by the dashed line 11. The mobile control unit 6 can likewise be supplied with power via the suspension means for the transport device 1 and, alternatively, via the on-board electrical system of the vehicle 7. This mobile control unit can also be linked with the host computer 5 via the wired data-exchange connection. The mobile control unit 6 can be supplied, for example, with the current software versions for the controllers in the vehicle 2 via this data exchange connection.

The mobile control unit is attached removably to the transport device 1. The advantage of this is that in the event of a test showing up a malfunction that necessitates removing the vehicle from the assembly line, the mobile control unit 6 can remain with the vehicle. The fact that the information concerning the detected fault is stored facilitates the necessary corrective action, which in itself is an advantage. An additional benefit is that the mobile control unit 6 contains the information as to which components have already been installed in the vehicle and to what extent the necessary software has already been loaded. As a result, the vehicle can easily be re-integrated into the production process.

The drawing shows a connecting line 7 leading from the mobile control unit 6 to a diagnostic connector 8 in the vehicle 2. The mobile control unit 6 can initiate and monitor appropriate test steps via this diagnostic connector 8. In addition, software can be transferred from the mobile control unit 6 to the corresponding controllers in the vehicle via this diagnostic connector. Especially if the mobile control unit is not designed to activate/deactivate the terminal 3, the connecting line 7 can be configured such that, on external initiation, the mobile control unit 6 can also supply power to the on-board electrical system of the vehicle 2 via this connecting line 7.

It can also be seen from the drawing that both the mobile control unit 6 and the host computer 5 may be provided with a transmitter and receiver unit 9 and 10. These permit wireless communication between the mobile control unit 6 and the host computer 5 or other control computers, for example test stations along the production line or assembly workers' hand terminals.

1. Transport device (1) for a motor vehicle (2) or partially assembled motor vehicle (2) during the production process, the transport device (1) being configured to receive a motor vehicle (2) or partially assembled motor vehicle (2), said motor vehicle (2) or partially assembled motor vehicle (2) being conveyable by means of the transport-device (1) to the various work stations, and the transport device (1) having a continuous and contact-free power supply during the production process, wherein the transport device (1) is provided with a terminal (3) for supplying power to the on-board electrical system of the motor vehicle (2) or partially assembled motor vehicle (2) to be conveyed by the transport device (1), the on-board electrical system of the motor vehicle (2) or partially assembled motor vehicle (2) being connectable (4) to said terminal (3) and said terminal (3) being supplied with-electrical energy via the contact-free power supply to the transport device (1).

2. The transport device of claim 1, wherein the terminal (3) can be activated and deactivated by a control unit(5, 6).

3. The transport device of claim 2, wherein the control unit (5, 6) is a centralised host computer (5).

4. The transport device of claim 2, wherein the control unit (5, 6) is a mobile control unit (6, 11) that can be attached removably to the transport device (1) or to the motor vehicle (2) or partially assembled motor vehicle (2) being conveyed by the transport device (1); power can be supplied to said mobile control unit (6) via the transport device (1) or via the vehicle's on-board electrical system.

5. The transport device of claim 4, wherein the mobile control unit (6) can be connected up (7) to a diagnostic connector (8) in the vehicle.

6. Transport device according to claim 1, wherein a mobile control unit (6) can be attached removably to the transport device (1) or to the motor vehicle. (2) or partially assembled motor vehicle (2) being conveyed by the transport device (1); power can be supplied to said mobile control unit (6) via the transport device (1) or via the vehicle's on-board electrical system, and the mobile control unit (6) can be connected up (7) to a diagnostic connector (8) in the vehicle.

7. Transport device according to claim 4, wherein the transport device (1) is integrated in a network for wired data exchange with a host computer (5), and that when mounted, the mobile control unit (6) is likewise integrated in the wired data-exchange network.

8. Transport device according to claim 4, wherein the mobile control unit (6) is equipped with a transmitter/receiver unit (9) for wireless data exchange with a host computer (5, 10) or with other stationary or mobile control computers.
